(19) United States
(12) Patent Application Publication
(10) Pub. No.: US 2014/0041586 A1
(43) Pub. Date: Feb. 13, 2014

(54) Masking Device for Vapor Deposition of Organic Material of Organic Electroluminescent Diode

(71) Applicants: Taipi Wu, Shenzhen City (CN); Yifan Wang, Shenzhen City (CN)

(72) Inventors: Taipi Wu, Shenzhen City (CN); Yifan Wang, Shenzhen City (CN)

(73) Assignee: Shenzhen China Star Optoelectronics Technology Co., LTD., Shenzhen City, Guangdong (CN)

(21) Appl. No.: 13/699,636

(22) PCT Filed: Aug. 17, 2012
(86) PCT No.: PCT/CN12/80284

§ 371 Date: Nov. 22, 2012

(30) Foreign Application Priority Data
Aug. 10, 2012 (CN) 201210284906.1

(51) Int. Cl. B05C 21/00

(52) U.S. Cl. CPC B05C 21/005
USPC 118/720

(57) ABSTRACT

The present invention provides a masking device for vapor deposition of organic material of an organic electroluminescent diode, including a mask frame and a plurality of divide shallow masks mounted on the mask frame. Gaps are formed between the divide shallow masks. The gap formed between two adjacent ones of the divide shallow masks is identical. The mask frame is rectangular in shape and has a central portion forming a receiving opening. The number of the divide shallow masks is determined according to width of the receiving opening of the mask frame and widths of the divide shallow masks. The overall width of all the divide shallow masks plus the widths of the gaps therebetween is greater than or equal to the width of the receiving opening. This arrangement helps realizing size enlargement of mask for vapor deposition of the diode and also facilitates vapor deposition of the organic material.

### BACKGROUND OF THE INVENTION

1. Field of the Invention

The present invention relates to an organic electroluminescent diode, and in particular to a masking device for vapor deposition of organic material of an organic electroluminescent diode.

2. The Related Arts

An organic light-emitting diode or organic light-emitting diode display (OLED) is also referred to as an organic electroluminescent diode, which is a novel displaying technology of which the development was dated back to the middle of the 20th century. The organic electroluminescent diode has various advantages over a liquid crystal display, such as being fully solid state, active emission of light, high brightness, high contrast, being ultra thin, low cost, low power consumption, fast response, wide view angle, wide range of operation temperature, and being capable of flexible displaying. The structure of the organic electroluminescent diode generally comprises a substrate, an anode, a cathode, and an organic function layer and the principle of light emission is that multiple layers of organic materials that are of extremely small thickness is formed between the anode and the cathode through vapor deposition, whereby positive and negative carriers, when injected into the organic semiconductor films, re-combine with each other to generate light. The organic function layer of the organic electroluminescent diode is generally made up of three function layers, which are respectively a hole transport layer (HTL), an emissive layer (EML), and an electron transport layer (ETL). Each of the function layers can be a single layer or more than one layer. For example, the hole transport layer sometimes is further divided into a hole injection layer and a hole transport layer and the electron transport layer may also be divided into an electron transport layer and an electron injection layer. However, they are of substantially the same function and are thus collectively referred to as the hole transport layer and the electron transport layer.

Currently, the manufacture of a full color organic electroluminescent diode is generally done with three methods, which are RGB juxtaposition and individual emission method, white light in combination with color filter method, and color conversion method, among which the RGB juxtaposition and individual emission method is most promising and has the most practical applications.

However, in the process of manufacturing an organic electroluminescent diode with the RGB juxtaposition and individual emission method, metal masks are needed to achieve vapor deposition of organic material on partial areas of a light emission pixel of a light emission layer on a glass substrate and thus realize color displaying. With the development of the organic electroluminescent diode, especially the active matrix organic light-emitting diode (AMOLED), the product size of the organic electroluminescent diode and the size of the glass substrate used are both being increased. This requires a continuous increase of the size of metal masks for vapor deposition. The metal mask is generally of a small thickness (often not exceeding 50 um) and the vapor deposition operation of the organic electroluminescent diode requires extremely high precision of alignment between the metal mask and the glass substrate (positional error between a unit component of the metal mask and a pixel unit of the glass substrate being between −3 um to +3 um). A production process for a size-enlarged organic electroluminescent diode often leads to defect products due to organic material being vapor-deposited on other areas caused by incorrect alignment between the metal mask and the glass substrate, so as to greatly affect the manufacture performance and manufacture expense. Thus, these technical issues of size enlargement of metal mask and precise alignment with the glass substrate after the enlargement of size impose a constraint to the development of the size enlargement of the organic electroluminescent diode.

### SUMMARY OF THE INVENTION

An object of the present invention is to provide a masking device for vapor deposition of organic material of an organic electroluminescent diode, which comprises a plurality of divide shallow masks jointed to a mask frame to realize size enlargement of a vapor deposition mask of an organic electroluminescent diode and to also facilitate vapor deposition of organic material for a large-sized organic electroluminescent diode.

To achieve the object, the present invention provides a masking device for vapor deposition of organic material of an organic electroluminescent diode, which comprises: a mask frame and a plurality of divide shallow masks mounted on the mask frame. Gaps are formed between the divide shallow masks. The gap between every two adjacent ones of the divide shallow masks is identical. The mask frame is rectangular in shape and has a central portion defining a rectangular receiving opening. The divide shallow masks are mounted by being juxtaposed in a width direction of the receiving opening and have a number determined according to width of the receiving opening of the mask frame and width of the divide shallow masks. The overall width of all the divide shallow masks plus widths of the gaps therebetween is greater than or equal to the width of the receiving opening.

The receiving opening of the mask frame has a size determined according to size of a light emission layer of an organic electroluminescent diode that is subjected to vapor deposition.

The divide shallow masks have identical structure and size and each of the divide shallow masks comprises an effective opening zone and two ineffective zones arranged at opposite ends of the effective opening zone.

The effective opening zone of the divide shallow masks forms openings corresponding to sub-pixel points of pixel units of the light emission layer of the organic electroluminescent diode and the ineffective zones of the divide shallow masks have free ends that are respectively coupled to the mask frame so as to mount the divide shallow masks to the mask frame.

The openings formed in the effective opening zone of the divide shallow masks are slot type openings.

The width of the gap between adjacent ones of the divide shallow masks is greater than or equal to width of the sub-pixel points of the pixel units of the light emission layer of the organic electroluminescent diode.

The sub-pixel points of the pixel units are one of any color sub-pixel point of three color sub-pixel points of red, green, and blue colors.

The openings formed in the effective opening zone of the divide shallow masks are slit type openings.

The masking device further comprises a plurality of cover plates each arranged on the gap between adjacent ones of the divide shallow masks. The cover plates have a width that is greater than the width of the gap between adjacent ones of the divide shallow masks and smaller than distance between two adjacent ones of the effective opening zones.

The cover plates are mounted to the mask frame.

The present invention also provides a masking device for vapor deposition of organic material of an organic electroluminescent diode, which comprises: a mask frame and a plurality of divide shallow masks mounted on the mask frame, gaps being formed between the divide shallow masks, the gap between every two adjacent ones of the divide shallow masks being identical, the mask frame being rectangular in shape and having a central portion defining a rectangular receiving opening, the divide shallow masks being mounted by being juxtaposed in a width direction of the receiving opening and having a number determined according to width of the receiving opening of the mask frame and width of the divide shallow masks, overall width of all the divide shallow masks plus widths of the gaps therebetween being greater than or equal to the width of the receiving opening;

wherein the receiving opening of the mask frame has a size determined according to size of a light emission layer of an organic electroluminescent diode that is subjected to vapor deposition;

wherein the divide shallow masks have identical structure and size, each of the divide shallow masks comprising an effective opening zone and two ineffective zones arranged at opposite ends of the effective opening zone;

wherein the effective opening zone of the divide shallow masks forms openings corresponding to sub-pixel points of pixel units of the light emission layer of the organic electroluminescent diode and the ineffective zones of the divide shallow masks have free ends that are respectively coupled to the mask frame so as to mount the divide shallow masks to the mask frame;

wherein the openings formed in the effective opening zone of the divide shallow masks are slot type openings;

wherein the width of the gap between adjacent ones of the divide shallow masks is greater than or equal to width of the sub-pixel points of the pixel units of the light emission layer of the organic electroluminescent diode; and

wherein the sub-pixel points of the pixel units are one of any color sub-pixel point of three color sub-pixel points of red, green, and blue colors.

The efficacy of the present invention is that the present invention provides a masking device for vapor deposition of organic material of an organic electroluminescent diode, which comprises a plurality of divide shallow masks jointed to each other on the mask frame so as to realize size enlargement of the mask for vapor deposition of organic material of an organic electroluminescent diode thereby overcoming the problems that cannot be handled by vapor deposition techniques of the active matrix organic electroluminescent diode, reducing defect of packaging, and realizing size enlargement of an organic electroluminescent diode with reduced manufacture cost and improved manufacture performance.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing the structure of a masking device for vapor deposition of organic material of an organic electroluminescent diode according to an embodiment of the present invention;

FIG. 2 is a localized enlarged view of an effective opening zone of a divide shallow mask of FIG. 1;

FIG. 3 is a schematic view illustrating assembling of a mask frame and divide shallow masks of a masking device for vapor deposition of organic material of an organic electroluminescent diode according to another embodiment of the present invention; and

FIG. 4 is a schematic view showing the structure of the masking device for vapor deposition of organic material of an organic electroluminescent diode according to the embodiment of FIG. 3.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

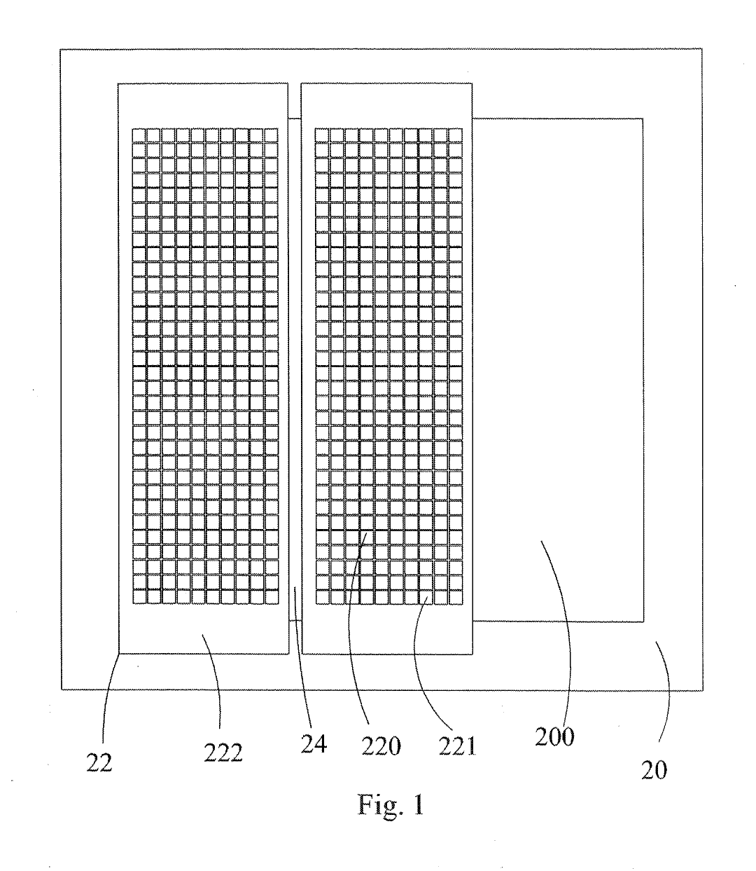

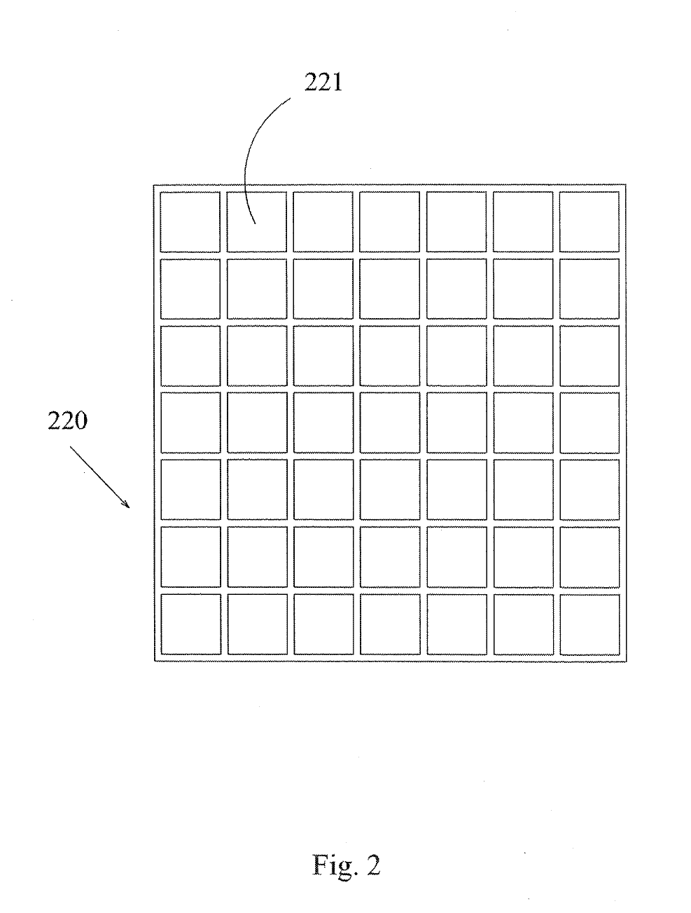

Referring to FIGS. 1 and 2, the present invention provides a masking device for vapor deposition of organic material of an organic electroluminescent diode, which comprises: a mask frame 20 and a plurality of divide shallow masks 22 mounted on the mask frame 20. A gap 24 is formed between adjacent ones of the divide shallow masks 22 and the gap 24 between every two of the divide shallow masks 22 is identical. The plurality of divide shallow masks 22 is jointed to form a complete size-enlarged mask for vapor deposition. The mask frame 20 is rectangular in shape and has a central portion forming a rectangular receiving opening 200. The divide shallow masks 22 are mounted by being juxtaposed in a width direction of the receiving opening 200 and the number of the divide shallow mask is determined according to width of the receiving opening 200 of the mask frame 20 and width of the divide shallow masks 22. The overall width of all the divide shallow masks 22 plus widths of the gaps 24 therebetween is greater than or equal to the width of the receiving opening 200.

The size of the receiving opening 200 of the mask frame 20 is determined according to the size of the light emission layer (not shown) of an organic electroluminescent diode, and they are usually identical to each other.

In the instant embodiment, the divide shallow masks 22 have the same structure and size. Each of the divide shallow masks 22 comprises an effective opening zone 220 and two ineffective zones 222 arranged at opposite ends of the effective opening zone 220.

The effective opening zone 220 of the divide shallow masks 22 defines a plurality of openings 221, which is arranged to correspond to sub-pixel points of pixel units of the light emission layer of an organic electroluminescent diode in order to effect precise alignment in a vapor deposition process. The two ineffective zones 222 of each divide shallow mask 22 have free ends that are respectively coupled to the mask frame 20 so as to mount the divide shallow mask 22 to the mask frame 20.

The openings 221 of the divide shallow masks 22 are identical in size. In the instant embodiment, the openings 221 are slot type openings.

The divide shallow masks 22 are jointed to each other in a spaced manner and the width of the gap 24 between adjacent ones of the divide shallow masks 22 is greater than or equal to the width of the sub-pixel points of the pixel units of the light emission layer of the organic electroluminescent diode. The sub-pixel points of the pixel units are one of any color sub-pixel point of three color sub-pixel points of red, green, and blue colors (R, G, B).

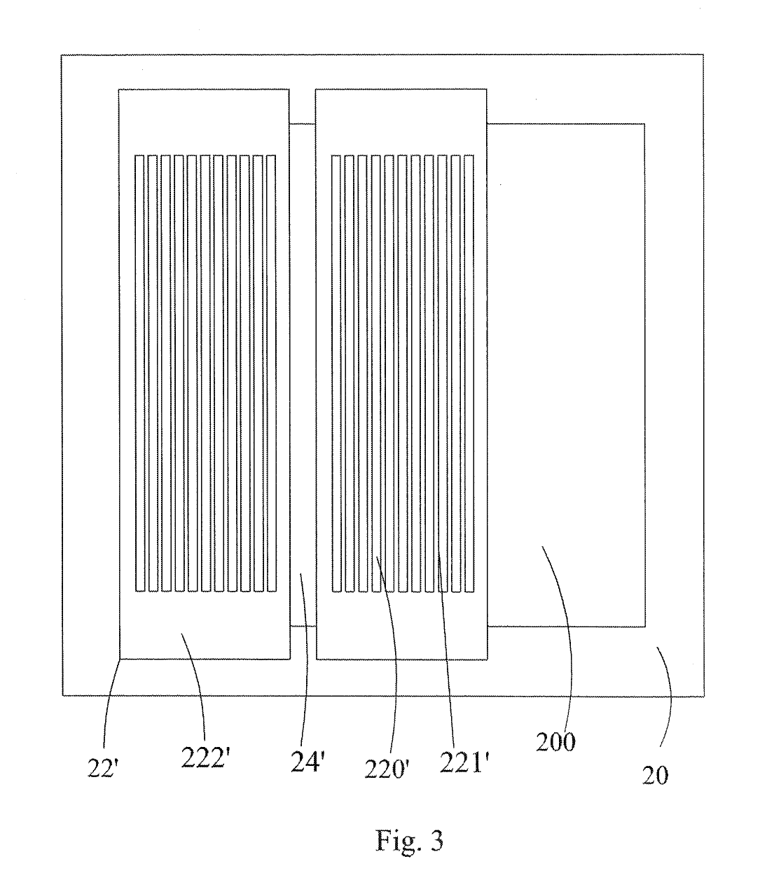

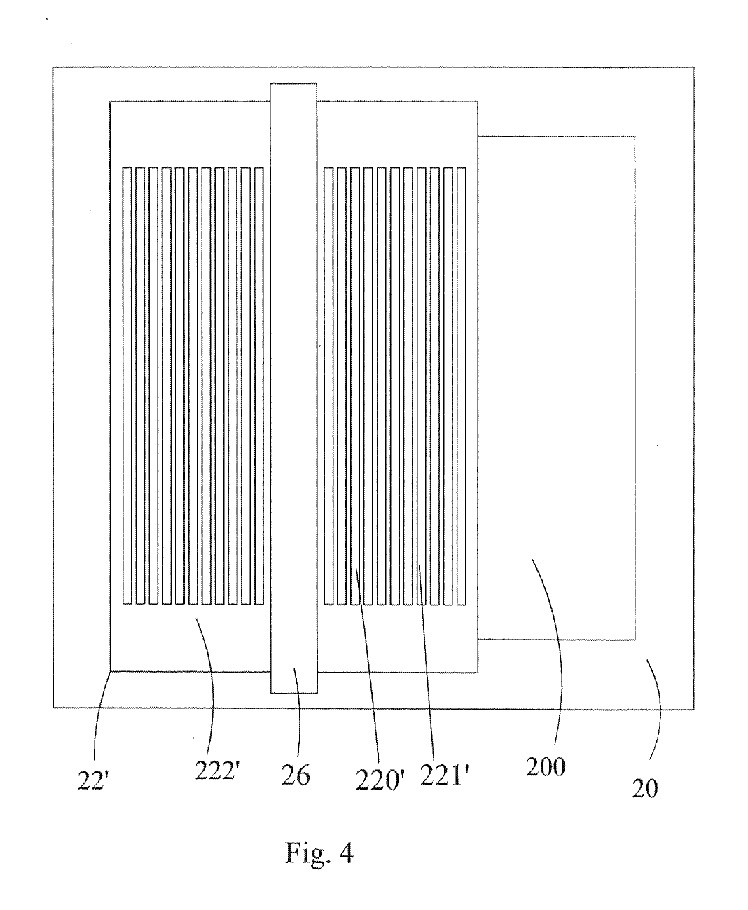

Referring to FIGS. 3 and 4, which show schematic views of a masking device for vapor deposition of organic material of an organic electroluminescent diode according to another embodiment of the present invention, in the instant embodiment, the masking device for vapor deposition of organic material of an organic electroluminescent diode comprises: a mask frame 20, a plurality of divide shallow masks 22′ mounted on the mask frame 20, and a cover plate 26 arranged on a gap 24′ formed between two adjacent ones of the divide shallow masks 22′. The gap 24′ formed between every adjacent two divide shallow masks 22′ is identical so that the plurality of divide shallow masks 22′ can be jointed to form a complete size-enlarged mask for vapor deposition. The mask frame 20 is rectangular in shape and has a central portion forming a rectangular receiving opening 200. The divide shallow masks 22′ are mounted by being juxtaposed in a width direction of the receiving opening 200 and the number of the divide shallow mask is determined according to width of the receiving opening 200 of the mask frame 20 and width of the divide shallow masks 22′. The overall width of all the divide shallow masks 22′ plus widths of the gaps 24′ therebetween is greater than or equal to the width of the receiving opening 200.

The size of the receiving opening 200 of the mask frame 20 is determined according to the size of the light emission layer (not shown) of an organic electroluminescent diode, and they are usually identical to each other.

The divide shallow masks 22′ have the same structure and size. Each of the divide shallow masks 22′ comprises an effective opening zone 220′ and an ineffective zone 222 arranged to circumferentially surround the effective opening zone 220.

The effective opening zone 220′ of the divide shallow masks 22′ forming openings 221′ that are arranged to correspond to the sub-pixel points of the pixel units of the light emission layer of an organic electroluminescent diode in order to effect precise alignment in a vapor deposition process. Opposite free ends of the ineffective zone 222′ of each divide shallow mask 22′ are respectively coupled to the mask frame 20 so as to mount the divide shallow mask 22′ to the mask frame 20.

The openings 221′ of the divide shallow masks 22′ are identical in size. In the instant embodiment, the openings 221′ are slit type openings.

The divide shallow masks 22′ are jointed to each other in a spaced manner and the width of the gap 24′ between adjacent ones of the divide shallow masks 22′ is greater than or equal to the width of the sub-pixel points of the pixel units of the light emission layer of the organic electroluminescent diode. The sub-pixel points of the pixel units are one of any color sub-pixel point of three color sub-pixel points of red, green, and blue colors (R, G, B).

The cover plate 26 is mounted to the mask frame 20 and the cover plate 26 has a width that is greater than the width of the gap 24′ between two adjacent ones of the divide shallow masks 22′ and smaller than the distance between the effective opening zones 220′ of two adjacent ones of the divide shallow masks 22′ so as to completely cover the gap 24′ between the two adjacent ones of the divide shallow masks 22′ but not to affect the openings 221′ of the effective opening zones 220′.

In summary, the present invention provides a masking device for vapor deposition of organic material of an organic electroluminescent diode, which comprises a plurality of divide shallow masks jointed to each other on the mask frame so as to realize size enlargement of the mask for vapor deposition of organic material of an organic electroluminescent diode thereby overcoming the problems that cannot be handled by vapor deposition techniques of the active matrix organic electroluminescent diode, reducing defect of packaging, and realizing size enlargement of an organic electroluminescent diode with reduced manufacture cost and improved manufacture performance.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A masking device for vapor deposition of organic material of an organic electroluminescent diode, comprising: a mask frame and a plurality of divide shallow masks mounted on the mask frame, gaps being formed between the divide shallow masks, the gap between every two adjacent ones of the divide shallow masks being identical, the mask frame being rectangular in shape and having a central portion defining a rectangular receiving opening, the divide shallow masks being mounted by being juxtaposed in a width direction of the receiving opening and having a number determined according to width of the receiving opening of the mask frame and width of the divide shallow masks, overall width of all the divide shallow masks plus widths of the gaps therebetween being greater than or equal to the width of the receiving opening.

2. The masking device for vapor deposition of organic material of an organic electroluminescent diode as claimed in claim 1, wherein the receiving opening of the mask frame has a size determined according to size of a light emission layer of an organic electroluminescent diode that is subjected to vapor deposition.

3. The masking device for vapor deposition of organic material of an organic electroluminescent diode as claimed in claim 1, wherein the divide shallow masks have identical structure and size, each of the divide shallow masks comprising an effective opening zone and two ineffective zones arranged at opposite ends of the effective opening zone.

4. The masking device for vapor deposition of organic material of an organic electroluminescent diode as claimed in claim 3, wherein the effective opening zone of the divide shallow masks forms openings corresponding to sub-pixel points of pixel units of the light emission layer of the organic electroluminescent diode and the ineffective zones of the divide shallow masks have free ends that are respectively coupled to the mask frame so as to mount the divide shallow masks to the mask frame.

5. The masking device for vapor deposition of organic material of an organic electroluminescent diode as claimed in claim 3, wherein the openings formed in the effective opening zone of the divide shallow masks are slot type openings.

6. The masking device for vapor deposition of organic material of an organic electroluminescent diode as claimed in claim 4, wherein the width of the gap between adjacent ones of the divide shallow masks is greater than or equal to width of the sub-pixel points of the pixel units of the light emission layer of the organic electroluminescent diode.

7. The masking device for vapor deposition of organic material of an organic electroluminescent diode as claimed in claim 6, wherein the sub-pixel points of the pixel units are one of any color sub-pixel point of three color sub-pixel points of red, green, and blue colors.

8. The masking device for vapor deposition of organic material of an organic electroluminescent diode as claimed in claim 3, wherein the openings formed in the effective opening zone of the divide shallow masks are slit type openings.

9. The masking device for vapor deposition of organic material of an organic electroluminescent diode as claimed in claim 8 further comprising a plurality of cover plates each arranged on the gap between adjacent ones of the divide shallow masks, the cover plates having a width that is greater than the width of the gap between adjacent ones of the divide shallow masks and smaller than distance between two adjacent ones of the effective opening zones.

10. The masking device for vapor deposition of organic material of an organic electroluminescent diode as claimed in claim 9, wherein the cover plates are mounted to the mask frame.

11. A masking device for vapor deposition of organic material of an organic electroluminescent diode, comprising: a mask frame and a plurality of divide shallow masks mounted on the mask frame, gaps being formed between the divide shallow masks, the gap between every two adjacent ones of the divide shallow masks being identical, the mask frame being rectangular in shape and having a central portion defining a rectangular receiving opening, the divide shallow masks being mounted by being juxtaposed in a width direction of the receiving opening and having a number determined according to width of the receiving opening of the mask frame and width of the divide shallow masks, overall width of all the divide shallow masks plus widths of the gaps therebetween being greater than or equal to the width of the receiving opening;
wherein the receiving opening of the mask frame has a size determined according to size of a light emission layer of an organic electroluminescent diode that is subjected to vapor deposition;
wherein the divide shallow masks have identical structure and size, each of the divide shallow masks comprising an effective opening zone and two ineffective zones arranged at opposite ends of the effective opening zone;
wherein the effective opening zone of the divide shallow masks forms openings corresponding to sub-pixel points of pixel units of the light emission layer of the organic electroluminescent diode and the ineffective zones of the divide shallow masks have free ends that are respectively coupled to the mask frame so as to mount the divide shallow masks to the mask frame;
wherein the openings formed in the effective opening zone of the divide shallow masks are slot type openings;
wherein the width of the gap between adjacent ones of the divide shallow masks is greater than or equal to width of the sub-pixel points of the pixel units of the light emission layer of the organic electroluminescent diode; and
wherein the sub-pixel points of the pixel units are one of any color sub-pixel point of three color sub-pixel points of red, green, and blue colors.
